(19) United States
(12) Patent Application Publication
(10) Pub. No.: US 2010/0134506 A1
(43) Pub. Date: Jun. 3, 2010

(54) IMAGE DISPLAY APPARATUS AND IMAGE SEARCHING METHOD USING THE SAME

(76) Inventors: Si-Jeong RO, Seoul (KR); Jeong-Hwan HWANG, Seongnam (KR)

Correspondence Address: BIRCH STEWART KOLASCH & BIRCH, PO BOX 747, FALLS CHURCH, VA, 22040-0747, US

(21) Appl. No.: 12/628,957

(22) Filed: Dec. 1, 2009

(30) Foreign Application Priority Data
Dec. 2, 2008 (KR) 10-2008-0121445

(51) Int. Cl. G09G 5/36

(52) U.S. Cl. 345/545

(57) ABSTRACT

An image display apparatus, and an image searching method using the same. The apparatus includes: a channel buffer configured to temporarily store information relating to a moving image being currently reproduced; a display unit configured to display a plurality of moving images or still images relating to a plurality of moving image sections included in the moving image being currently reproduced at one region of a screen, and configured to reproduce a moving image corresponding to one moving image section selected by a user among the plurality of moving image sections at another region of the screen; and a controller configured to activate an image searching function, and to control the display unit to reproduce the selected moving image section based on the moving image-related information temporarily stored in the channel buffer.

### CROSS-REFERENCE TO RELATED APPLICATIONS

Pursuant to 35 U.S.C. §119(a), this application claims the benefit of earlier filing date and right of priority to Korean Application No. 10-2008-0121445, filed on Dec. 2, 2008, the contents of which are incorporated by reference herein in its entirety.

### BACKGROUND OF THE INVENTION

1. Field of the Invention

The present disclosure relates to an image display apparatus and an image searching method using the same, and particularly, to an image searching method capable of simply and rapidly searching content included in a moving image, and a corresponding image display apparatus.

2. Discussion of the Background

Generally, an image display apparatus serves to reproduce moving images or audio stored in a memory or received from outside. An example of a image display apparatus is a television that receives a broadcast signal and outputs the received broadcast signal.

The television may be an analogue type television for receiving an analogue type broadcast signal and outputting the received broadcast signal. Alternatively, there is a digital type television for receiving a digital type broadcast signal and outputting the received broadcast signal has been recently presented to the public. The digital type of television may also receive an image signal through an Internet network and outputs the received image signal.

The image display apparatus may be also implemented as a mobile terminal such as a mobile communication terminal, a navigation apparatus, a telematics terminal, a Portable Multimedia Player (PMP), and a laptop computer. Alternatively, the image display device may be implemented as a stationary terminal such as a desktop computer and an IP TV.

Techniques for reproducing an image received by the image display apparatus may include a streaming method for real-time receiving a signal and reproducing the received signal. The streaming method does not reproduce files such as a voice signal or a moving image stored in a memory after being downloaded from an Internet network, etc.

When an image is received via the streaming method at a higher speed than a speed of the image display apparatus can process information, redundant images may be temporarily stored in a channel buffer.

### SUMMARY OF THE INVENTION

An object of the present disclosure is to provide an image searching method capable of simply and rapidly search content included in a moving image, and capable of reproducing the content, along with a corresponding image display apparatus.

To achieve these and other advantages and in accordance with the purpose of the present disclosure, as embodied and broadly described herein, there is provided an image display apparatus, comprising: a channel buffer configured to temporarily store information relating to a moving image being currently reproduced; a display unit configured to display a plurality of moving images or still images relating to a plurality of moving image sections included in the moving image being currently reproduced at one region of a screen, and configured to reproduce a moving image corresponding to one moving image section selected by a user among the plurality of moving image sections at another region of the screen; and a controller configured to activate an image searching function, and to control the display unit to reproduce the selected moving image section by using the moving image-related information temporarily stored in the channel buffer.

According to a first aspect of the present disclosure, the controller may control the channel buffer to maintain the moving image-related information stored in the channel buffer once the image searching function is activated.

According to a second aspect of the present disclosure, the controller may determine whether information relating to a moving image included in the selected moving image section exists in the channel buffer, and if so, may control the display unit to reproduce the moving image based on the moving-image related information stored in the channel buffer.

According to a third aspect of the present disclosure, the controller may delete information relating to a moving image not included in the selected moving image section from the channel buffer, among the moving image-related information stored in the channel buffer.

According to a fourth aspect of the present disclosure, the controller may control the display unit to scroll a plurality of moving images or still images displayed on one region of the screen.

According to a fifth aspect of the present disclosure, the controller may control the display unit to reproduce a moving image corresponding to the selected moving image section, on an entire part of a region set to reproduce a moving image on the screen.

According to a sixth aspect of the present disclosure, the image display apparatus may further comprise a user input unit configured to receive an input for designating one moving image section among the plurality of moving image sections, and an input for determining a moving image section corresponding to the designated moving image section as the selected moving image section.

According to a seventh aspect of the present disclosure, the display unit may display still images relating to the plurality of moving image sections on one region of the screen, and the controller may control a moving image relating to the selected moving image section to be displayed on one region of the screen, rather than a still image relating to the designated moving image section among the displayed still images.

According to an eighth aspect of the present disclosure, the display unit may display a still image or a moving image relating to the designated moving image section in the middle of other plurality of still images or moving images.

According to a ninth aspect of the present disclosure, the display unit may display a still image or a moving image relating to the designated moving image section with a larger size than other plurality of still images or moving images.

To achieve these and other advantages and in accordance with the purpose of the present disclosure, as embodied and broadly described herein, there is also provided an image searching method by an image display apparatus, the method comprising: activating an image searching function; displaying, on one region of a screen, a plurality of moving images or still images relating to a plurality of moving image sections included in a moving image being currently reproduced; and reproducing a moving image corresponding to one moving image section selected by a user among the plurality of moving image sections at another region of the screen, based on moving image-related information temporarily stored in a channel buffer.

According to a first aspect of the present disclosure, the method may further comprise maintaining the moving image or the moving image-related information pre-stored in the channel buffer once an image searching function is activated.

According to a second aspect of the present disclosure, the step of reproducing may comprise: determining whether information relating to a moving image included in the selected moving image section exists in the channel buffer; and if so, reproducing a moving image based on the moving-image related information stored in the channel buffer.

According to a third aspect of the present disclosure, the step of reproducing may further comprise deleting information relating to a moving image not included in the selected moving image section from the channel buffer, among the moving image-related information stored in the channel buffer.

According to a fourth aspect of the present disclosure, the method may further comprise scrolling a plurality of moving images or still images displayed on one region of the screen.

According to a fifth aspect of the present disclosure, in the step of reproducing, a moving image corresponding to the selected moving image section may be reproduced on an entire part of a region set to reproduce a moving image on the screen.

According to a sixth aspect of the present disclosure, the method may further comprise: receiving an input for designating one moving image section among the plurality of moving image sections; and receiving an input for determining a moving image section corresponding to the designated moving image section as the selected moving image section.

According to a seventh aspect of the present disclosure, in the step of displaying, still images relating to the plurality of moving image sections may be displayed on one region of the screen, and the step of displaying may further comprise displaying a moving image relating to the designated moving image section on one region of the screen, rather than a still image relating to the designated moving image section among the displayed still images.

According to an eighth aspect of the present disclosure, in the step of displaying, a still image or a moving image relating to the designated moving image section may be displayed in the middle of other plurality of still images or moving images.

According to a ninth aspect of the present disclosure, in the step of displaying, a still image or a moving image relating to the designated moving image section may be displayed with a larger size than other plurality of still images or moving images.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

In the drawings:

FIG. 1 is a block diagram of an image display apparatus according to a first embodiment of the present disclosure;

FIG. 2 is a flowchart showing an image searching method by the image display apparatus according to a first embodiment of the present disclosure;

FIG. 3 is a view showing a state that a moving image is being reproduced by the image display apparatus according to a first embodiment of the present disclosure;

FIG. 4 is a view showing a state that an image searching function of the image display apparatus has been activated according to a first embodiment of the present disclosure;

FIG. 5 is a view showing a state that a scroll function has been applied to moving images or still images when performing the image searching function of the image display apparatus according to a first embodiment of the present disclosure;

FIG. 6 is a view showing a state that a designated moving or still image is being displayed when performing the image searching function of the image display apparatus according to a first embodiment of the present disclosure;

FIG. 7 is a view showing a state that a moving image corresponding to a selected moving image section is being reproduced on one region of a screen, by using moving image-related information temporarily stored in a channel buffer according to an embodiment of the present disclosure; and

FIG. 8 is a view showing a state that a moving image corresponding to a selected moving image section is being reproduced on another region of a screen, by using moving image-related information received from outside according to an embodiment of the present disclosure.

### DETAILED DESCRIPTION OF THE INVENTION

Description will now be given in detail of the present disclosure, with reference to the accompanying drawings.

Hereinafter, an image display apparatus according to the present disclosure will be explained in more detail with reference to the attached drawings. The suffixes attached to components of the present disclosure, such as ‘module’ and ‘unit or portion’ were used for facilitation of the detailed description of the present disclosure. Therefore, the suffixes do not have different meanings from each other.

An image display apparatus according to the present disclosure may include a television, a DVD player, a mobile phone, a smart phone, a laptop computer, a digital broadcasting terminal, personal digital assistants (PDA), a portable multimedia player (PMP), a navigation, or any other device that receives an image from outside and reproduces the received image.

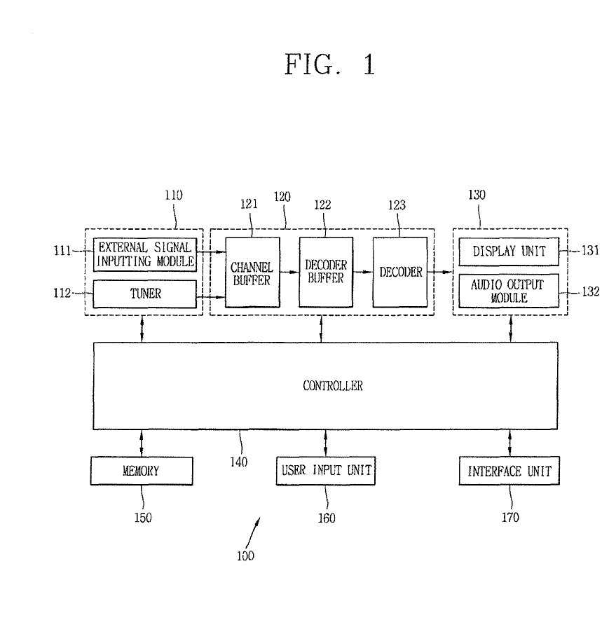

FIG. 1 is a block diagram of an image display apparatus according to a first embodiment of the present disclosure.

An image display apparatus 100 may comprise an image receiver 110, an image processor 120, an image output unit 130, a controller 140, a memory 150, a user input unit 160, an interface unit 170, etc. The image display apparatus 100 may have components less than or more than the components shown in FIG. 1.

Hereinafter, each of the components will be explained.

The image receiver 110 receives an image signal and/or image related information from outside of an image display apparatus, and then transmits the received signal or information to the image processor 120. The image receiver 110 may include an external signal receiving module 111 and a tuner 112.

The external signal receiving module 111 may receive an external signal received from an external device such as a Digital Versatile Disk (DVD), a Set Top Box and a camcorder, or a wired/wireless Internet network.

As the wireless Internet technique, may be used Wireless LAN (WLAN) (Wi-Fi), Wireless broadband (Wibro), World Interoperability for Microwave Access (Wimax), High Speed Downlink Packet Access (HSDPA), etc.

As the wired Internet technique, may be used Ethernet, Hybrid Fiber Coax (HFC), Asymmetric Digital Subscriber Line (ADSL), Very High-Data Rate Digital Subscriber Line (VDSL), Fiber-To-The-Home (FTTH), Power Line Communication (PLC), etc.

The external device and the image display apparatus 100 may be connected to each other by a wire or wirelessly through the external signal receiving module 111.

In the case of wirelessly connecting the external device and the image display apparatus 100 to each other, they may be connected to each other through short range communication. As the short range communication, may be used Bluetooth, Radio Frequency Identification (RFID), (IrDA, Infrared Data Association (IrDA), Ultra Wideband (UWB), ZigBee, etc.

The tuner 112 receives a broadcast signal and/or broadcast-related information from an external broadcast management server through a broadcast channel. The broadcast channel may include a satellite channel and a terrestrial channel. The broadcast management server may indicate a server for generating a broadcast signal and/or broadcast-related information and transmitting the generated signal and/or information, or a server for receiving a generated broadcast signal and/or broadcast-related information and transmitting the received signal and/or information to a terminal. The broadcast signal may include not only a TV broadcast signal, a radio broadcast signal, and a data broadcast signal, but also a hybrid broadcast signal where a data broadcast signal is combined with a TV broadcast signal or a radio broadcast signal.

The broadcast-related information may indicate information relating to a broadcast channel, a broadcast program, or a broadcast service provider. The broadcast-related information may be also provided through a mobile communication network.

The broadcast-related information may be implemented in various manners, for example, an Electronic Program Guide (EPG) of Digital Multimedia Broadcasting (DMB), or an Electronic Service Guide (ESG) of Digital Video Broadcast-Handheld (DVB-H).

The tuner 112 may receive a digital broadcast signal by using a digital broadcast system such as Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), and Integrated Services Digital Broadcast-Terrestrial (ISDB-T). The tuner 112 may be also configured to be suitable for not only the digital broadcast system, but also any other broadcast systems.

An image signal and/or image-related information received through the image receiver 110 may be stored in a memory 150.

The image processor 120 receives an image signal from the image receiver 110, and processes the received image signal so that the image output unit 130 can output the received image signal. The image processor 120 may include a channel buffer 121, a decoder buffer 122, a decoder 123, etc.

The channel buffer 121 may receive an image signal from the image receiver 110, and temporarily store the received image signal therein. The image signal is stored in the form of data stream that video data where moving image reproduction and audio data for audio reproduction are mixed together.

The data stored in the channel buffer 121 may be deleted after being transmitted to the decoder buffer 122. Alternatively, the data stored in the channel buffer 121 may be maintained for a predetermined time after being transmitted to the decoder buffer 122.

The decoder buffer 122 temporarily stores the audio data and video data separated from the data stream. And, the temporarily stored audio data and video data is transmitted to the decoder 123.

The data stored in the decoder buffer 122 may be immediately deleted after being transmitted to the decoder 123. Alternatively, the data stored in the decoder buffer 122 may be deleted after a predetermined time lapses.

The audio decoder 125 may convert the audio data into a form that can be used by the controller 140 or the image output unit 130. The audio data may be implemented as various forms.

The decoder 126 may convert the video or audio data into a form that can be used by the controller 140 or the image output unit 130. The audio and/or video data may be implemented as various forms. For instance, the decoder 126 may encode/decode video data implemented as Audio Video Interleaved (AVI), Motion Picture Expert Group (MPEG), DivX, XviD, Windows Media Video (WMV) codec, etc.

The image output unit 130 reproduces video (image) and/or audio by using the data converted by the decoder 123. And, the image output unit 130 may include a display unit 131 and an audio output module 132.

The display unit 131 displays information processed by the image display apparatus 100. For instance, when the image display apparatus 100 is in a moving image output mode, a moving image is output. Alternatively, when the image display apparatus 100 is in an Internet communication mode, a User Interface (UI) or a Graphic User Interface (GUI) relating to Internet communication is output.

The display unit 131 may include at least one of a liquid crystal display (LCD), a thin film transistor-liquid crystal display (TFT LCD), an organic light-emitting diode (OLED), a flexible display, a 3D display, a plasma display panel (PDP), a Multi Display Tube (MDT).

The audio output module 132 outputs audio data decoded by the audio decoder 125. The audio output module 132 may include at least one of a dynamic speaker, an electrostatic speaker and a planar-magnetic speaker.

The controller 140 controls the entire operation of the image display apparatus 100. For instance, the controller 140 processes data received by the image receiver 110, or data stored in the memory 150. For instance, the controller 140 may include a Digital Signal Processor (DSP).

The memory 150 may store programs to process and control the controller 140, or temporarily store input/output data. The memory 150 may include at least one of a flash memory type, a hard disk type, a multimedia card micro type, a card type (e.g., SD or XD memory, etc.), Random Access Memory (RAM) Static Random Access Memory (SRAM), Read-Only Memory (ROM), Electrically Erasable Programmable Read-Only Memory (EEPROM), Programmable Read-Only Memory (PROM), a magnetic memory, a magnetic disc, and an optical disc. The image display apparatus 100 may operate a web storage which performs a storage function of the memory 150 on the Internet.

The user input unit 160 receives a signal to control the operation of the image display apparatus 100. The signal may indicate a signal to control the operation (Rewind, Fast-Forward, Pause, Record, etc.) of a moving image being currently reproduced. Alternatively, the signal may indicate a signal to control the operation of the image display apparatus 100, such as power ON/OFF, reservation recording, Internet communication module Enable/Disable, short range wireless communication module Enable/Disable, broadcast channel change function, volume control function, mute function, etc. Not only the signal to control the operation of the image display apparatus 100, but also audio data or video data may be directly input to the user input unit 160 by a user through a camera or a microphone.

The signals may be directly input to the user input unit 160, or indirectly input by a wire/wireless remote controller.

The interface unit 170 is often implemented to couple the image display apparatus 100 with external devices. Typical external devices include wired/wireless headphones, external chargers, power supplies, storage devices configured to store data (e.g., audio, video, pictures, etc.), earphones, and microphones, among others. In addition, the interface unit 170 may be configured using a wired/wireless data port, a card socket (e.g., for coupling to a memory card, a subscriber identity module (SIM) card, a user identity module (UIM) card, a removable user identity module (RUIM) card, etc.), audio input/output ports and video input/output ports.

For a hardware implementation, the embodiments described above may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, the embodiments may be executed by the controller 140.

For a software implementation, the embodiments described herein may be implemented with separate software modules, such as procedures and functions, each of which perform one or more of the functions and operations described herein. The software codes can be implemented with a software application written in any suitable programming language and may be stored in memory (for example, the memory 150), and executed by a controller or processor (for example, the controller 140).

As shown in FIG. 1, the channel buffer 121 may temporarily store information relating to a moving image being currently reproduced. The information relating to a moving image being currently reproduced may include reproduction time data about a moving image being currently reproduced and/or a stored moving image, packet number data, pointer data, etc.

The reproduction time data may indicate data having time recorded therein, the time taken from reproduction start time of a stored moving image, to reproduction start time of a corresponding screen. The packet number data may indicate an identification number for identifying each packet which constitutes a moving image being currently reproduced. And, the pointer data may indicate an identifier for specifying a memory region on the channel buffer 121 where the data packet is stored. Each packet which constitutes a moving image being currently reproduced may be provided with one reproduction time data, one packet number data, and one pointer data.

As shown in FIG. 1, the display unit 131 may display, on one region of a screen, a plurality of moving images or still images relating to a plurality of moving image sections obtained by segmenting a moving image being currently reproduced.

The plurality of moving image sections may indicate a set of moving images obtained by segmenting a moving image being currently reproduced according to a predetermined basis. Alternatively, the plurality of moving image sections may indicate a set of moving images obtained by segmenting a moving image being currently reproduced according to a predetermined time interval or data size. Still alternatively, the plurality of moving image sections may indicate a set of moving images obtained by segmenting a moving image being currently reproduced by a user.

The plurality of still images relating to the moving image sections may indicate screens included in the plurality of moving image sections. And, the still images may be start screens of the respective moving image sections, or may be screens designated by the user among the respective moving image sections.

The plurality of moving images relating to the moving image sections may indicate moving images included in the plurality of moving image sections. The moving images may indicate moving images reproduced for a predetermined time from start time points of the respective moving image sections. Alternatively, the moving images may indicate moving images reproduced at predetermined sections designated by the user among the respective moving image sections.

The plurality of moving images or still images relating to the moving image sections may be output by using information temporarily stored in the channel buffer 121 or the memory 150. The plurality of moving images relating to the moving image sections may be temporarily stored in the channel buffer 121 or the memory 150 in the form of data having low picture quality.

The display unit 131 may reproduce, on another region of the screen, a moving image corresponding to one moving image section selected by the user among the plurality of moving image sections.

The moving image selected by the user may be reproduced by using information relating to the moving image temporarily stored in the channel buffer 121. Another region of the screen may indicate an entire part of a region is preset to reproduce a moving image on the screen.

The display unit 131 may display still images relating to the plurality of moving image sections on one region of the screen. And, once the user designates one moving image section, the display unit 131 may display a moving image relating to the designated moving image section on one region of the screen.

The display unit 131 may display a still image or a moving image relating to the designated moving image section in the middle of other plurality of still images or moving images. Alternatively, the display unit may display a still image or a moving image relating to the designated moving image section with a larger size than other plurality of still images or moving images.

The display unit 131 may display a plurality of moving images or still images displayed on the screen in a scrolling manner.

Referring to FIG. 1, the controller 140 may activate an image searching function according to the user's selection. If the image searching function has been activated, then the user selects one moving image section by using a still image(s) or a moving image(s) relating to a plurality of moving image sections displayed on the display unit 131. The controller 140 may control the display unit 131 to reproduce the selected moving image section by using information relating to a moving image temporarily stored in the channel buffer 121.

For this, the controller 140 may control the channel buffer 121 to maintain moving image-related information pre-stored in the channel buffer 121 once the image searching function has been activated.

The moving image-related information temporarily stored in the channel buffer 121 is not necessarily deleted, but may be maintained for facilitation of an image searching function. This may allow the image searching function to be rapidly performed without requiring to receive new moving image-related information.

The controller 140 may determine whether information relating to a moving image included in the selected moving image section exists in the channel buffer 121. If information relating to a moving image included in the selected moving image section exists in the channel buffer 121, the controller 140 may control the display unit 131 to reproduce a moving image by using the moving image-related information stored in the channel buffer 121.

Whether information relating to a moving image included in the selected moving image section exists in the channel buffer 121 may be determined based on reproduction time data, packet number data, pointer data, etc. stored in the channel buffer 121. The controller 140 may recognize reproduction time of the moving image section selected by the user. The controller 140 may recognize packet number data of the moving image information corresponding to the reproduction time of the selected moving image section. And, the controller 140 may read pointer data indicating a memory address of the channel buffer 121 where packet number data of the moving image information is stored, thereby determining whether the moving image information has been stored in the channel buffer 121.

The controller 140 may delete information relating to a moving image not included in the selected moving image section from the channel buffer 121, among the moving image-related information stored in the channel buffer 121. This may allow the channel buffer 121 to have a redundant space.

The controller 140 may control the display unit 131 to scroll a plurality of moving images or still images displayed on one region of the screen.

The controller 140 may control the display unit 131 to reproduce a moving image corresponding to the selected moving image section, on an entire part of a region set to reproduce a moving image on the screen.

The controller 140 may control the display unit 131 to display only still images relating to a plurality of moving image sections on one region of the screen.

Once the user's input for designating one moving image section among the moving image sections is received, the controller 140 may control the display unit 131 to display a moving image, rather than a still image relating to the designated moving image section.

Also, the user input unit 160 may receive an input for designating one moving image section among the plurality of moving image sections, and an input for determining a moving image section corresponding to the designated moving image section as the selected moving image section.

And, the user input unit 160 may also receive an input for scrolling still images or moving images displayed on one region of the screen.

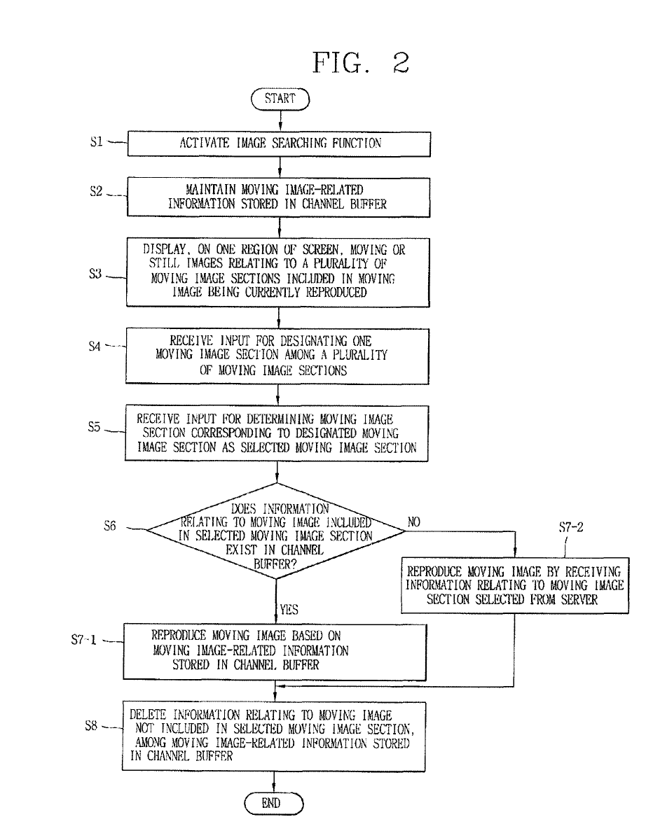

FIG. 2 is a flowchart showing an image searching method by the image display apparatus according to a first embodiment of the present disclosure.

The image display apparatus 100 may activate an image searching function once the user's input is received, or a preset condition is satisfied (S1). The image searching function may be activated so that the user can search and view a moving image section where his or her desired content is included.

Once the image searching function is activated, the image display apparatus 100 may control the channel buffer 121 to maintain moving image-related information pre-stored in the channel buffer 121 (S2).

Once the image searching function is activated, the image display apparatus 100 may display, on one region of a screen, moving images or still images relating to a plurality of moving image sections included in a moving image being currently reproduced (S3). The moving images or still images may be implemented as thumbnail photos obtained by contracting capacities of scenes included in the moving image.

The image display apparatus 100 may receive the user's input for designating one moving image section among the plurality of moving image sections (S4). When the image display apparatus 100 includes a touch screen as the user input unit 160, the user's input for designating one moving image section may be performed by touching the screen on which the moving images or still images are displayed, or by manipulating a remote controller, etc.

The image display apparatus 100 may display a still image or a moving image relating to the designated moving image section in the middle of other plurality of still images or moving images. Alternatively, the image display apparatus 100 may display a still image or a moving image relating to the designated moving image section with a larger size than other plurality of still images or moving images. Still alternatively, the image display apparatus 100 may display a moving image, rather than a still image relating to the designated moving image section.

The image display apparatus 100 may receive an input for determining a moving image section corresponding to the designated moving image section as the selected moving image section (S5).

The image display apparatus 100 may determine whether information relating to a moving image included in the selected moving image section exists in the channel buffer 121 (S6). Here, the determination may be performed based on the moving image-related information stored in the channel buffer 121, i.e., reproduction time data, packet number data, pointer data, etc.

If information relating to a moving image included in the selected moving image section exists in the channel buffer 121, the image display apparatus 100 may control the display unit 131 to reproduce a moving image based on the moving-image related information stored in the channel buffer 121 (S7-1).

On the contrary, if information relating to a moving image included in the selected moving image section does not exist in the channel buffer 121, the image display apparatus 100 may reproduce a moving image by receiving moving image section-related information selected from a server or the memory 160 (S7-2).

The image display apparatus 100 may delete information relating to a moving image not included in the selected moving image section from the channel buffer, among the moving image-related information stored in the channel buffer 121.

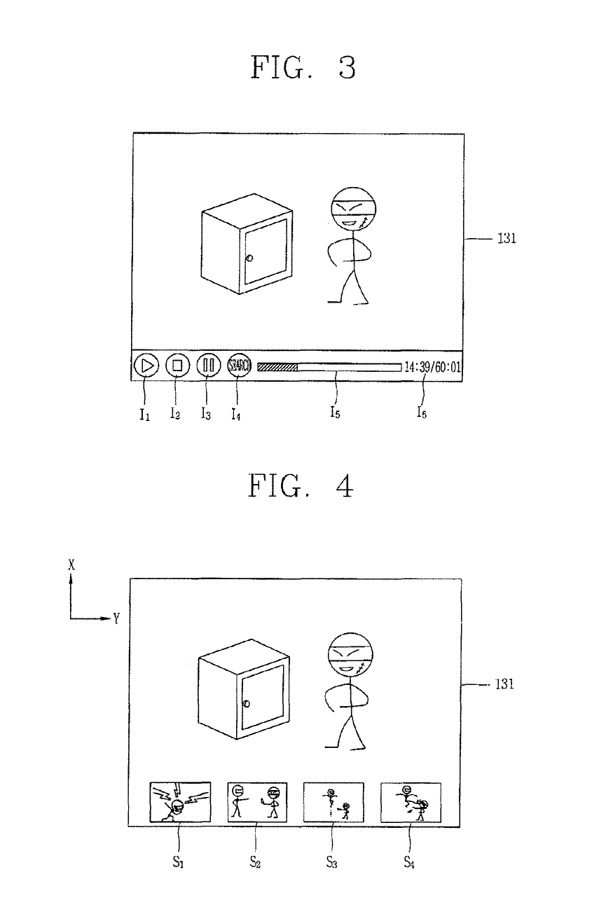

FIG. 3 is a view showing a state that a moving image is being reproduced by the image display apparatus according to a first embodiment of the present disclosure.

As shown in FIG. 3, the display unit 131 of the image display apparatus 100 may display a moving image on the screen. While the display unit 131 displays a moving image, the audio output module 132 may output audio corresponding to the moving image.

As shown in FIG. 3, the display unit 131 may display, on the screen, various additional information and icons relating to additional functions, as well as the moving image.

As shown in FIG. 3, an icon (I1) for reproducing other moving image may be displayed on the screen of the image display apparatus 100. An icon (I2) may be displayed on the screen, for instructing reproduction of a moving image. Also, an icon (I3) may be displayed for instructing the moving image being currently reproduced to be temporarily stopped. Also, an icon (I4) may be displayed for activating an image searching function.

On the screen of the image display apparatus 100, icons (I5 and/or I6) may be displayed for visualizing a reproduction ratio of the moving image being currently reproduced. The icon (I5) may be displayed in the form of a bar, and the icon (I6) may be displayed in the form of a timer indicating the current reproduction time with respect to the entire reproduction time.

When the image display apparatus 100 includes a touch screen as the user input unit 160, a touch may be input to a position where a corresponding icon is located. As a result, the corresponding icon performs its own function. Alternatively, when the image display apparatus 100 includes a mouse, a keypad, etc. as the user input unit 160, a cursor for controlling the image display apparatus 100 is moved to a position where a corresponding icon is located. As a result, the corresponding icon performs its own function.

Instead of or in addition to the method for displaying the icons (I1˜I6) relating to the function of the image display apparatus 100 on the screen, other methods may be used. More concretely, adjustable keys of the user input unit 160 are mapped with the functions of the image display apparatus 100. Once a key input is received, a function of the image display apparatus 100 corresponding to the input key is performed.

FIG. 4 is a view showing a state that an image searching function of the image display apparatus has been activated according to a first embodiment of the present disclosure.

On one region of the screen, may be displayed a plurality of still images or moving images (S1, S2, S3, S4) relating to a plurality of moving image sections obtained by segmenting a moving image being currently reproduced.

As shown in FIG. 4, the plurality of still images or moving images (S1, S2, S3, S4) are displayed in a row in an X-axis direction. However, the plurality of still images or moving images (S1, S2, S3, S4) may be displayed in a row in a Y-axis direction or in a diagonal direction. Alternatively, the plurality of still images or moving images (S1, S2, S3, S4) may be arbitrarily displayed on any region of the screen.

The plurality of still images or moving images (S1, S2, S3, S4) may be displayed in the order of reproduction time, or in the order of sizes of moving images included in the respective moving image sections. Once the image searching function has been activated, the image display apparatus 100 may temporarily stop the moving image being currently reproduced, or continue to reproduce the moving image, or change the current reproduction speed.

The plurality of still images or moving images (S1, S2, S3, S4) may be implemented as complete still images, or complete moving images.

Alternatively, some of the plurality of still images or moving images (S1,S2,S3,S4) may be implemented as still images, and other thereof may be implemented as moving images (51, S2, S3, S4). For instance, information relating to a moving image section designated by the user may be displayed as moving images, whereas information relating to other moving image sections may be displayed as still images.

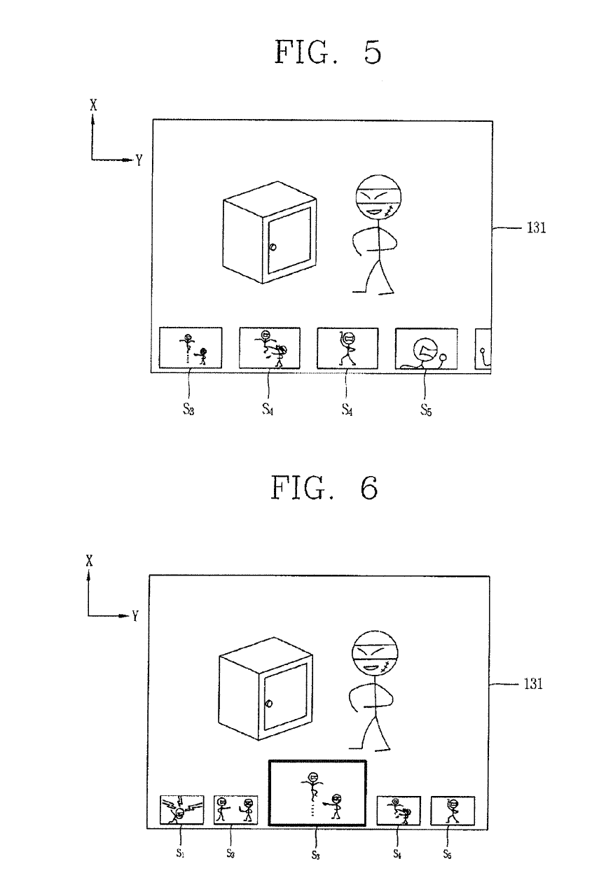

FIG. 5 is a view showing a state that a scroll function has been applied to moving images or still images when performing the image searching function of the image display apparatus according to a first embodiment of the present disclosure.

Referring to FIG. 5, once the user moves the plurality of still images or moving images (S1, S2, S3, S4) in one direction, the image display apparatus 100 applies a scroll function to the plurality of still images or moving images (S1, S2, S3, S4). Accordingly, new still images or moving images (S5, S6) may be displayed. The scroll function may be applicable in both the X-axis direction and Y-axis direction.

FIG. 6 is a view showing a state that a designated moving or still image is being displayed when performing the image searching function of the image display apparatus according to a first embodiment of the present disclosure.

Once the image searching function has been activated, the image display apparatus 100 displays, on one region of the screen, a plurality of moving images or still images (S1, S2, S3, S4, S5) relating to a plurality of moving image sections obtained by segmenting a moving image being currently reproduced.

As shown in FIG. 6, the user may receive an input for designating at least one moving image section among the plurality of moving image sections. The image display apparatus 100 may display a still image or a moving image (S3) relating to the moving image section designated by the user in the middle of other plurality of still images or moving images (S1, S2, S4, S5).

The image display apparatus 100 may display a still image or a moving image (S3) relating to the moving image section designated by the user with a larger size than other plurality of still images or moving images (S1, S2, S4, S5).

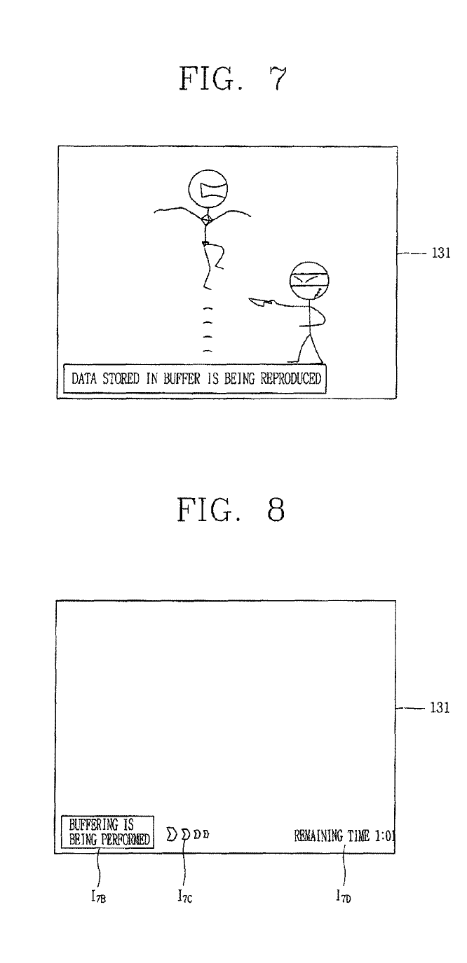

FIG. 7 is a view showing a state that a moving image corresponding to a selected moving image section is being reproduced on one region of the screen, by using the moving image-related information temporarily stored in the channel buffer.

As shown in FIG. 7, a moving image corresponding to a moving image section selected by the user may be reproduced on one region of the screen. When information relating to a moving image included in the selected moving image section exists in the channel buffer 121, the image display apparatus 100 may reproduce the information based on the moving image-related information stored in the channel buffer 121.

The image display apparatus 100 may display on the screen that a moving image corresponding to a selected moving image section is being reproduced on one region of the screen, by using the moving image-related information temporarily stored in the channel buffer.

The display unit 131 may display, on a specific region of the screen, that the image display apparatus 100 is reproducing a moving image corresponding to a selected moving image section on the screen, by using the moving image-related information temporarily stored in the channel buffer 121.

As shown in FIG. 7, a moving image corresponding to the selected moving image section may be reproduced on an entire part of a region preset to reproduce a moving image on the screen.

FIG. 8 is a view showing a state that a moving image corresponding to a selected moving image section is being reproduced on another region of the screen, by using the moving image-related information received from outside.

When information relating to a moving image included in a selected moving image section does not exist in the channel buffer 121, the image display apparatus 100 may receive information relating to the selected moving image section from outside thereby to reproduce the information on another region of the screen.

The display unit 131 may display, on specific regions (I7B and I7C) of the screen, that the image display apparatus 100 is reproducing a moving image corresponding to the selected moving image section by using moving image-related information received from outside.

The display unit 131 may further display, on the screen, an icon (I7D) indicating remaining time taken for the image display apparatus 100 to receive a moving image corresponding to the selected moving image section from outside.

According to the first embodiment of the present disclosure, the method may be implemented by a program code stored in a computer-readable storage medium. The computer-readable storage medium may include ROM, RAM, CD-ROM, a magnetic tape, a floppy disc, an optical data storage device, etc. Also, the media may be implemented as carrier wave (e.g., transmission through the Internet).

As aforementioned, in the image display apparatus according to the present disclosure, still images or moving images relating to image searching are displayed by utilizing moving image-related information temporarily stored in the channel buffer. This may provide various information necessary to perform an image searching function to the user.

Furthermore, a moving image included in a selected moving image section is reproduced by utilizing moving image-related information temporarily stored in the channel buffer. This may shorten the time taken to receive the moving image.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An image display apparatus, comprising:
a display unit;
a channel buffer configured to temporarily store first information relating to a moving image currently being reproduced on the display unit; and
a controller configured to
control the display unit to display, on a first region of a screen, a plurality of moving or still images related to a plurality of moving image sections included in the moving image currently being reproduced, and reproduce, on a second region of the screen, a moving image corresponding to a moving image section selected by a user among the plurality of moving image sections, and
activate an image searching function, and to control the display unit to reproduce the selected moving image section based on the first information.

2. The image display apparatus of claim 1, wherein the controller is configured to control the channel buffer to maintain the first information stored in the channel buffer once the image searching function is activated.

3. The image display apparatus of claim 2, wherein the controller is configured to determine whether second information relating to a moving image included in the selected moving image section exists among the first information stored in the channel buffer, and if the second information exists in the channel buffer, control the display unit to reproduce the moving image based on the second information stored in the channel buffer.

4. The image display apparatus of claim 3, wherein the controller is configured to delete third information, relating to a moving image not included in the selected moving image section, from the channel buffer, among the first information stored in the channel buffer.

5. The image display apparatus of claim 1, wherein the controller is configured to control the display unit to scroll a plurality of moving images or still images displayed on one region of the screen.

6. The image display apparatus of claim 1, wherein the controller is configured to control the display unit to reproduce the moving image corresponding to the selected moving image section on the first region of the screen in response to a user selection.

7. The image display apparatus of claim 1, further comprising:
a user input unit configured to receive an input for designating one moving image section among the plurality of moving image sections, and an input configured to select the selected moving image section.

8. The image display apparatus of claim 7,
wherein the plurality of moving or still images includes a plurality of still images relating to non-selected moving image sections.

9. The image display apparatus of claim 7, wherein the first region is located in a center of the second region.

10. The image display apparatus of claim 7, wherein the controller is configured to control the display unit to display the selected moving image section larger than any one of the plurality of still or moving images.

11. An image searching method by an image display apparatus, the method comprising:
reproducing a moving image on the image display apparatus;
temporarily storing first information relating to the moving image currently being reproduced;
activating an image searching function;
displaying, on a first region of a screen of the image display apparatus, a plurality of moving or still images related to a plurality of moving image sections included in the moving image currently being reproduced; and
reproducing, on a second region of the screen, a moving image corresponding to a moving image section selected by a user among the plurality of moving image sections and based on the first information.

12. The method of claim 11, further comprising:
maintaining the first information pre-stored in the channel buffer once an image searching function is activated.

13. The method of claim 12, wherein the step of reproducing a moving image corresponding to a moving image section selected by a user comprises:
determining whether second information relating to a moving image included in the selected moving image section exists among the first information stored in the channel buffer; and
if the second information exists in the channel buffer, reproducing the moving image based on the second information stored in the channel buffer.

14. The method of claim 13, wherein the step of reproducing further comprises:
deleting third information relating to a moving image not included in the selected moving image section from the channel buffer, among the first information stored in the channel buffer.

15. The method of claim 11, further comprising:
scrolling a plurality of moving images or still images displayed on one region of the screen.

16. The method of claim 11, further comprising:
reproducing the moving image corresponding to the selected moving image section on the first region of the screen in response to a user selection.

17. The method of claim 11, further comprising:
receiving an input for designating one moving image section among the plurality of moving image sections; and
receiving an input for selecting the selected moving image section.

18. The method of claim 17, wherein the plurality of moving or still images includes a plurality of still images relating to non-selected moving image sections.

19. The method of claim 17, wherein the first region is located in a center of the second region.

20. The method of claim 17, wherein the step of displaying comprises:
displaying the selected moving image section larger than any one of the plurality of still or moving images.
